(19) United States
(12) Patent Application Publication
(10) Pub. No.: US 2005/0130968 A1
(43) Pub. Date: Jun. 16, 2005

(54) Fungicidal 4-(2-aminopyridin-4-yl)-N-phenyl-1,3,5-triazin-2-amine derivatives

(76) Inventors: Nicholas Martin Irvine, Westfield, IN (US); Ronald Ross JR., Zionsville, IN (US); Michael John Ricks, Zionsville, IN (US); Kristy Bryan, Carmel, IN (US); Carla Jean Rasmussen Klittich, Zionsville, IN (US)

Correspondence Address: DOW AGROSCIENCES LLC, 9330 ZIONSVILLE RD, INDIANAPOLIS, IN, 46268, US

(21) Appl. No.: 10/957,471

(22) Filed: Oct. 1, 2004

Related U.S. Application Data
(60) Provisional application No. 60/508,631, filed on Oct. 3, 2003.
(60) Provisional application No. 60/552,608, filed on Mar. 12, 2004.

(51) Int. Cl. A01N 43/66

(52) U.S. Cl. 514/241; 514/227.5; 514/235.5

(57) ABSTRACT

The present invention relates to triazine derivatives, especially 4-(2-aminopyridin-4-yl)-N-phenyl-1,3,5-triazin-2-amine derivatives and their use as fungicidal compositions. Novel compounds showing fungicidal activity are disclosed and further, novel compositions containing 4-(2-aminopyridin-4-yl)-N-phenyl-1,3,5-triazin-2-amine derivatives can be used in fungicide applications.

### FIELD OF THE INVENTION

This invention is related to the field of compounds having fungicidal activity and their use in fungicidal applications.

### BACKGROUND OF THE INVENTION

History is riddled with outbreaks of fungal diseases that have caused widespread human suffering. One need look no further than the Irish potato famine, which occurred from 1845 to 1860, where an estimated 1,000,000 people died, and an estimated 1,500,000 people emigrated, to see the effects of a fungal disease.

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield and the quality of the crop and consequently, increase the value. In most situations, the increase in value is worth at least three times the cost of the use of the fungicide. However, no one fungicide is useful in all situations. Consequently, research is being conducted to produce fungicides that are safer, that have better performance, that are easier to use, and that cost less.

WO 01/25220 discloses various triazine derivatives useful as inhibitors of enzymes in treating disease or disease symptoms. However, this reference does not relate to fungicidal applications of such derivatives. Additionally, WO 01/93682 discloses a method of protecting plants against attack by phytopathogenic organisms using the cited pyrimidineamine derivatives. However, this reference does not teach or suggest the use of triazines for such purpose.

### SUMMARY OF THE INVENTION

The present invention relates to triazine derivatives, especially 4-(2-aminopyridin-4-yl)-N-phenyl-1,3,5-triazin-2-amine derivatives and their use as fungicidal compositions. Novel compounds showing fungicidal activity are disclosed and further, novel compositions containing 4-(2-aminopyridin-4-yl)-N-phenyl-1,3,5-triazin-2-amine derivatives can be used in fungicide applications.

### DETAILED DESCRIPTION OF THE INVENTION

The 4-(2-aminopyridin-4-yl)-N-phenyl-1,3,5-triazin-2-amine derivatives of the present invention are represented by the following formula: 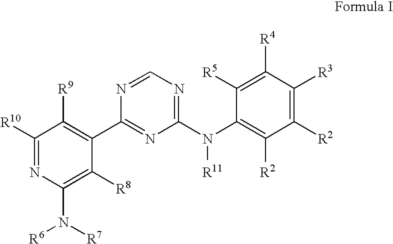
wherein
R¹, R², R³, R⁴, and R⁵ are each independently selected from H, alkyl, halogen, alkylhalo, alkoxy, alkoxyhalo or cyano;
R⁶ and R⁷ are each independently selected from H, alkyl, cycloalkyl, alkenyl, alkylalkenyl, alkylalkynyl, aryl, alkylaryl, alkylhalo, alkoxy, alkylalkoxy, alkylalkoxyalkoxy, alkylalkoxyhalo, alkylhydroxy, alkylaryloxy, or alkylamino, or when taken together R⁶ and R⁷ can form a saturated or unsaturated 5 or 6 membered ring selected from piperazine, piperidine, morpholine, thiomorpholine, pyrrolidine, oxazolidine, oxazolidinone, thiazolidine, tetrahydroisoquinoline, decahydroisoquinoline, pyrroline, and tetrahydropyridine, wherein the 5 or 6 membered ring can be additionally substituted with one or more alkyl, aryl, cycloalkyl, alkylaryl, alkoxy, halo, and/or amino groups; and
R⁸, R⁹, and R¹⁰ are each independently selected from hydrogen, alkyl, halogen, haloalkyl, and alkoxy, and
R¹¹ is selected from H, alkyl, alkenyl, alkylalkenyl, alkylalkynyl, CH₂OR¹², CH₂SR¹², —C(O)R¹², C(O)OR¹², SO₂R¹², SOR¹², or SR¹², wherein
R¹² is selected from alkyl, alkylalkoxy, alkylhalo or alkylphenyl, wherein the phenyl may be substituted by up to 3 groups selected from halo or alkyl.

Within the present specification, the term “alkyl” refers to an unbranched, or branched, carbon chain having from 1 to 6 carbon atoms (C₁-C₆ alkyl), including methyl, ethyl, propyl, butyl, isopropyl, isobutyl, tertiary butyl, heptyl, hexyl and the like, preferably from 1 to 4 carbon atoms (C₁-C₄ alkyl); and the terms “alkenyl”, or “alkynyl” refers to an unbranched, or branched, carbon chain having from 2 to 6 carbon atoms (C₂-C₆), including ethenyl, propenyl, butenyl, isopropenyl, isobutenyl, tertiary butenyl, hexyl, heptyl and the like, preferably from 2 to 4 carbon atoms (C₂-C₄). The term “cycloalkyl” refers to a C₃ to C₆ carbon ring, including cyclobutyl, cyclopropyl, cyclopentyl, cyclohexyl, cyclohexyl and the like. The term “alkoxy” refers to an OR substituent, wherein R is a C₁-C₆ unbranched or branched carbon chain, including methyl, ethyl, propyl, butyl, isopropyl, isobutyl, tertiary butyl, hexyl, heptyl and the like, preferably a C₁-C₄ carbon chain. Halogen or halo refers to one or more halogen atoms, defined as F, Cl, Br, and I. The term “alkoxyhalo” refers to an unbranched, or branched, chain alkoxy group substituted with one or more halo atoms. The term “alkylalkoxy” refers to an unbranched, or branched, alkyl group substituted with one or more alkoxy groups. The term “aryloxy” refers to an OR′, wherein R′ is a phenyl or substituted phenyl group. The term “alkylamino” refers to an alkyl group as defined above substituted with an amine, wherein the amine can be substituted with H, an alkyl group, or an aryl group or any combination thereof. The term “alkylalkoxyalkoxy” refers to an unbranched, or branched, alkyl group substituted with one or more alkoxy groups, wherein at least one of the alkoxy groups is additionally substituted with an additional alkoxy group (e.g. ROROR). The term “aryl” refers to a phenyl or substituted phenyl group. The term “alkylaryl” refers an unbranched, or branched, carbon chain having from 1 to 6 carbon atoms (C₁-C₆ alkyl) which also contains an aryl substituent which is a phenyl or substituted phenyl group.

While all the compounds of the present invention have fungicidal activity, certain classes of compounds may be preferred for reasons such as, for example, greater efficacy or ease of synthesis.

Throughout the specification, reference to the compounds of Formula I is read as also including salts of Formula I. Exemplary salts include: hydrochloride, hydrobromide, hydroiodide, and the like.

In one embodiment, the compounds of the present invention are those represented by Formula I wherein:
R⁶ and R⁷ are each independently selected from H, alkylalkoxy, alkylalkoxyalkoxy, or together form an oxazolidinone ring.

In general, the compounds of the present invention can be produced by reacting 2-chloro-4-(2-chloropyridin-4-yl)-1,3,5-triazine with an aniline, followed by amination of the 2-chloropyrinyl. General methods for these types of reactions are described in WO 0125220 and WO 0193682.

Another embodiment of the present invention is a use of a compound of Formula I, or salt thereof, for protection of a plant against attack by a phytopathogenic organism or the treatment of a plant infested by a phytopathogenic organism, comprising applying a compound of Formula I or a salt thereof, or a composition comprising said compound or salt thereof, to soil, a plant, a part of a plant, foliage, and/or seeds.

Additionally, another embodiment of the present invention is a composition useful for protecting a plant against attack by a phytopathogenic organism and/or treatment of a plant infested by a phytopathogenic organism comprising a compound of Formula I or a salt thereof and a phytologically acceptable carrier material.

The compounds are applied by any of a variety of known techniques, either as the compounds or as formulations comprising the compounds. For example, the compounds may be applied to the roots, seeds or foliage of plants for the control of various fungi, without damaging the commercial value of the plants. The materials are applied in the form of any of the generally used formulation types, for example, as solutions, dusts, wettable powders, flowable concentrates, or emulsifiable concentrates.

Preferably, the compounds of the present invention are applied in the form of a formulation, comprising one or more of the compounds of Formula I with a phytologically acceptable carrier. Concentrated formulations can be dispersed in water, or other liquids, for application, or formulations can be dust-like or granular, which can then be applied without further treatment. The formulations can be prepared according to procedures that are conventional in the agricultural chemical art.

The present invention contemplates all vehicles by which one or more of the compounds can be formulated for delivery and use as a fungicide. Typically, formulations are applied as aqueous suspensions or emulsions. Such suspensions or emulsions are produced from water-soluble, water suspendable, or emulsifiable formulations which are solids, usually known as wettable powders; or liquids, usually known as emulsifiable concentrates, aqueous suspensions, or suspension concentrates. As will be readily appreciated, any material to which these compounds can be added may be used, provided they yield the desired utility without significant interference with the activity of these compounds as antifungal agents.

Wettable powders, which may be compacted to form water dispersible granules, comprise an intimate mixture of one or more of the compounds of Formula I, an inert carrier and surfactants. The concentration of the compound in the wettable powder is usually from about 10% to about 90% by weight based on the total weight of the wettable powder, more preferably about 25 wt. % to about 75 wt. %. In the preparation of wettable powder formulations, the compounds can be compounded with any finely divided solid, such as prophyllite, talc, chalk, gypsum, Fuller's earth, bentonite, attapulgite, starch, casein, gluten, montmorillonite clays, diatomaceous earths, purified silicates or the like. In such operations, the finely divided carrier and surfactants are typically blended with the compound(s) and milled.

Emulsifiable concentrates of the compounds of Formula I comprise a convenient concentration, such as from about 10 wt. % to about 50 wt. % of the compound, in a suitable liquid, based on the total weight of the concentrate. The compounds are dissolved in an inert carrier, which is either a water miscible solvent or a mixture of water-immiscible organic solvents, and emulsifiers. The concentrates may be diluted with water and oil to form spray mixtures in the form of oil-in-water emulsions. Useful organic solvents include aromatics, especially the high-boiling naphthalenic and olefinic portions of petroleum such as heavy aromatic naphtha. Other organic solvents may also be used, such as, for example, terpenic solvents, including rosin derivatives, aliphatic ketones, such as cyclohexanone, and complex alcohols, such as 2-ethoxyethanol.

Emulsifiers which can be advantageously employed herein can be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulphonic acids, oil soluble salts or sulfated polyglycol ethers and appropriate salts of phosphated polyglycol ether.

Representative organic liquids which can be employed in preparing the emulsifiable concentrates of the compounds of the present invention are the aromatic liquids such as xylene, propyl benzene fractions; or mixed naphthalene fractions, mineral oils, substituted aromatic organic liquids such as dioctyl phthalate; kerosene; dialkyl amides of various fatty acids, particularly the dimethyl amides of fatty glycols and glycol derivatives such as the n-butyl ether, ethyl ether or methyl ether of diethylene glycol, and the methyl ether of triethylene glycol and the like. Mixtures of two or more organic liquids may also be employed in the preparation of the emulsifiable concentrate. Preferred organic liquids include xylene, and propyl benzene fractions, with xylene being most preferred. Surface-active dispersing agents are typically employed in liquid formulations and in an amount of from 0.1 to 20 percent by weight based on the combined weight of the dispersing agent with one or more of the compounds. The formulations can also contain other compatible additives, for example, plant growth regulators and other biologically active compounds used in agriculture.

Aqueous suspensions comprise suspensions of one or more water-insoluble compounds of Formula I or salts thereof, dispersed in an aqueous vehicle at a concentration in the range from about 5 to about 50 weight %, based on the total weight of the aqueous suspension. Suspensions are prepared by finely grinding one or more of the compounds, and vigorously mixing the ground material into a vehicle comprised of water and surfactants chosen from the same types discussed above. Other components, such as inorganic salts and synthetic or natural gums, may also be added to increase the density and viscosity of the aqueous vehicle. It is often most effective to grind and mix at the same time by preparing the aqueous mixture and homogenizing it in an implement such as a sand mill, ball mill, or piston-type homogenizer.

The compounds of Formula I or salts thereof, can also be applied as granular formulations, which are particularly useful for applications to the soil. Granular formulations usually contain from about 0.5 to about 10 wt. %, bases on the total weight of the granular formulation of the compound(s), dispersed in an inert carrier which consists entirely or in large part of coarsely divided inert material such as attapulgite, bentonite, diatomite, clay or a similar inexpensive substance. Such formulations are usually prepared by dissolving the compounds in a suitable solvent and applying it to a granular carrier which has been preformed to the appropriate particle size, in the range of from about 0.5 to about 3 mm. A suitable solvent is a solvent in which the compound is substantially or completely soluble. Such formulations may also be prepared by making a dough or paste of the carrier and the compound and solvent, and crushing and drying to obtain the desired granular particle.

Dusts containing the compounds of Formula I can be prepared by intimately mixing one or more of the compounds in powdered form with a suitable dusty agricultural carrier, such as, for example, kaolin clay, ground volcanic rock, and the like. Dusts can suitably contain from about 1 to about 10 wt. % of the compounds, based on the total weight of the dust.

The formulations may additionally contain adjuvant surfactants to enhance deposition, wetting and penetration of the compounds onto the target crop and organism. These adjuvant surfactants may optionally be employed as a component of the formulation or as a tank mix. The amount of adjuvant surfactant will typically vary from 0.01 to 1.0 % by volume, based on a spray-volume of water, preferably 0.05 to 0.5 volume %. Suitable adjuvant surfactants include, but are not limited to ethoxylated nonyl phenols, ethoxylated synthetic or natural alcohols, salts of the esters or sulphosuccinic acids, ethoxylated organosilicones, ethoxylated fatty amines and blends of surfactants with mineral or vegetable oils.

The formulations may optionally include combinations that contain other pesticidal compounds. Such additional pesticidal compounds may be fungicides, insecticides, nematocides, miticides, arthropodicides, bactericides or combinations thereof that are compatible with the compounds of the present invention in the medium selected for application, and not antagonistic to the activity of the present compounds. Accordingly, in such embodiments, the other pesticidal compound is employed as a supplemental toxicant for the same or for a different pesticidal use. The compounds of Formula I, or salt thereof, and the pesticidal compound in the combination can generally be present in a weight ratio of from 1:100 to 100:1.

Another embodiment of the present invention is a method for the control or prevention of fungal attack. This method comprises applying to the soil, plant, roots, foliage, seed or locus of the fungus, or to a locus in which the infestation is to be prevented (for example applying to cereal or grape plants), a fungicidal effective amount of one or more of the compounds. The compounds are suitable for treatment of various plants at fungicidal levels, while exhibiting low phytotoxicity. The compounds are useful both in a protectant and/or an eradicant fashion.

The compounds have been found to have significant fungicidal effect particularly for agricultural use. Many of the compounds are particularly effective for use with agricultural crops and horticultural plants.

In particular, the compounds effectively control a variety of undesirable fungi that infect useful plant crops. Activity has been demonstrated for a variety of fungi, including for example the following representative fungi species: Cucumber Anthracnose (Colletotricum lagenarium); Spot Blotch of Wheat (Cochliobolus sativus); Brown Rust of Wheat (Puccinia triticina); Speckled Leaf Blotch of Wheat (Septoria tritici); Rice Blast (Pyricularis oryzae); and Glume Blotch of Wheat (Leptosphaeria nodorum).

It will be understood by those in the art that the efficacy of the compound for the foregoing fungi establishes the general utility of the compounds as fungicides.

The compounds have broad ranges of efficacy as fungicides. The exact amount of the active material to be applied is dependent not only on the specific active material being applied, but also on the particular action desired, the fungal species to be controlled, and the stage of growth thereof, as well as the part of the plant or other product to be contacted with the compound. Thus, all the compounds, and formulations containing the same, may not be equally effective at similar concentrations or against the same fungal species.

The compounds are effective in use with plants in a disease-inhibiting and phytologically acceptable amount. The term “disease inhibiting and phytologically acceptable amount” refers to an amount of a compound that kills or inhibits the plant disease for which control is desired, but is not significantly toxic to the plant. This amount will generally be from about 1 to about 1000 ppm(parts per million), with 10 to 500 ppm being preferred. The exact concentration of compound required varies with the fungal disease to be controlled, the type of formulation employed, the method of application, the particular plant species, climate conditions, and the like. A suitable application rate is typically in the range from about 0.10 to about 4 pounds/acre (about 0.01 to 0.45 grams per square meter g/m²).

### EXAMPLES

These examples are provided to further illustrate the invention and are not meant to be construed as limiting.

As disclosed herein, all temperatures are given in degrees Celsius and all percentages are weight percentages, except for percent yields which are mole percentages, unless otherwise stated.

Preparation of Triazine derivatives

In general, the desired final product was prepared by the reaction of 2-chloro-4-(2-chloropyridin-4-yl)-1,3,5-triazine with an aniline as shown by scheme A, followed by amination of the 2-chloropyridinyl as shown in scheme B, C, or D. The synthesis of 2-chloro-4-(2-chloropyridin-4-yl)-1,3,5-triazine is described in WO 0125220.

The synthesis of N-(phenyl)-4-(2-chloropyridin-4-yl)-1,3,5-triazin-2-amines is also described in WO 0125220 from 2-chloro-4-(2-chloropyridin-4-yl)-1,3,5-triazine. More particularly, the N-(phenyl)-4-(2-chloropyridin-4-yl)-1,3,5-triazin-2-amines were prepared by the method illustrated in Scheme A: 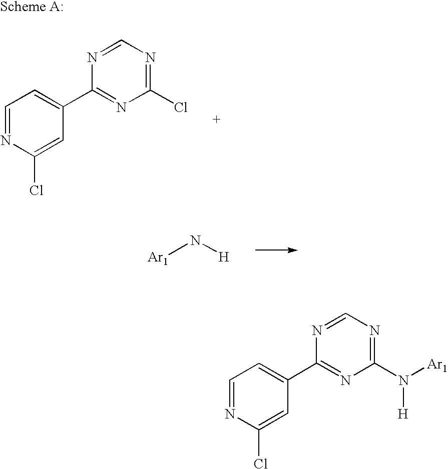
wherein Ar₁ is a phenyl group having substituents R¹, R², R³, R⁴ and R⁵ as defined by Formula I.

The amination of the N-(phenyl)-4-(2-chloropyridin-4-yl)-1,3,5-triazin-2-amines was conducted in several ways as shown in schemes B, C and D. Similar methods of displacing 2-chloropyridines with amines has been described in WO01/93682 and WO 0125220.

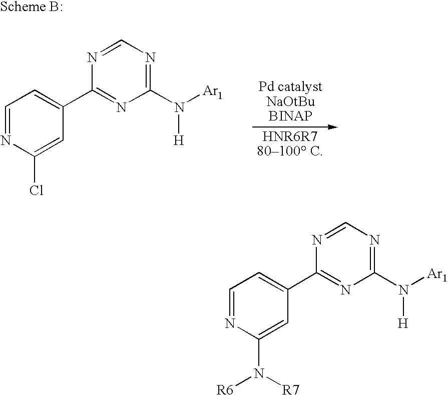

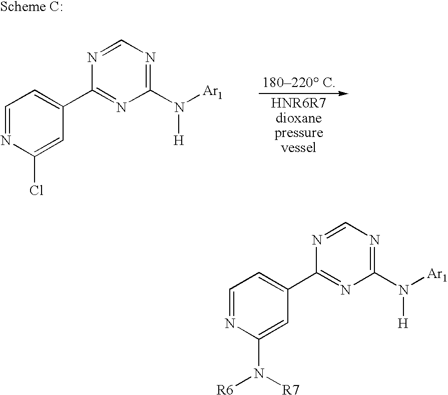

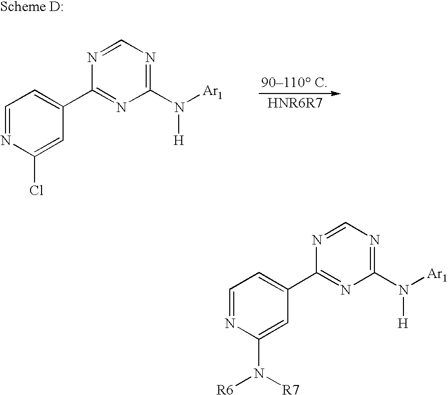

### EXAMPLES

### Preparation of N-(3-chlorophenyl)-4-(2-chloropyridin-4-yl)-1,3,5-triazin-2-amine:

Scheme A:

A mixture of 2-chloro-4-(2-chloropyridin-4-yl)-1,3,5-triazine (1.02 g, 4.48 mmol) and 2-chloroaniline (0.63 g, 4.94 mmol) in dioxane (50 mL) was heated at reflux for two hours. After cooling, the solution was concentrated and taken up into hexanes. The yellow solid was collected and dried in vacuo to provide N-(3-chlorophenyl)-4-(2-chloropyridin-4-yl)-1,3,5-triazin-2-amine (1.402 g, 4.41 mmol), mp 178-180° C.

### Preparation of N-(3-chlorophenyl)-4-{2-[(2-methoxy-1-methylethyl)amino]pyridin-4-yl}-1,3,5-triazin-2-amine (Compound 1) (R⁶═H, R⁷═CH(CH₃)CH₂OCH₃)

Scheme B:

A mixture of N-(3-chlorophenyl)-4-(2-chloropyridin-4-yl)-1,3,5-triazin-2-amine (0.60 g, 1.86 mmol), 1-methoxypropan-2-amine (0.30 mL, 2.83 mmol), 2,2′-bis(diphenylphosphino)-1,1′-binaphthyl (BINAP) (0.176 g, 0.28 mmol), sodium tert-butoxide (NaOtBu) (0.906 g, 9.43 mmol) in dioxane was degassed at room temperature with nitrogen for fifteen minutes. Tris(dibenzylideneacetone)-dipalladium(0) (palladium catalyst) (0.173 g, 0.19 mmol) was then added and the reaction mixture heated at 80° C. for two hours. After cooling, the solvent was removed in vacuo and the residue taken up into ethyl acetate. The organic mixture was washed with water and the aqueous back-extracted with ethyl acetate. The organics were combined, washed with brine and dried (anhydrous magnesium sulfate). After removal of the solvent, the residue was purified by silica gel column chromatography (eluent hexanes:etheyl acetate, 1:1) to provide N-(3-chlorophenyl)-4-{2-[(2-methoxy-1-methylethyl)amino]pyridin-4-yl}-1,3,5-triazin-2-amine (0.419 g, 1.13 mmol) as a yellow solid, mp 149-151° C.

The following compounds were made using the same general procedure as Compound 1:

(Compound 2) (R⁶═H, R⁷═CH(CH₃)CH₂OCH₃, Ar₁=3-chlorophenyl)

N-(3-chlorophenyl)-4-(2-{[(1S)-2-methoxy-1-methylethyl]amino}pyridin-4-yl)-1,3,5-triazin-2-amine, mp 152-156° C.

(Compound 3) (R⁶═H, R⁷═CH(CH₃)CH₂OCH₃, Ar₁=2-chlorophenyl)

N-(2-chlorophenyl)-4-{2-[(2-methoxy-1-methylethyl)amino]pyridin-4-yl}-1,3,5-triazin-2-amine, mp 139-140° C.

(Compound 4) (R⁶═H, R⁷═CH(CH₃)CH₂OCH₃, Ar₁=4-chlorophenyl)

N-(4-chlorophenyl)-4-{2-[(2-methoxy-1-methylethyl)amino]pyridin-4-yl}-1,3,5-triazin-2-amine, mp 198-200° C.

(Compound 5) (R⁶═H, R⁷═C(CH₃)₃, Ar₁=3-chlorophenyl)

4-[2-(tert-butylamino)pyridin-4-yl]-N-(3-chlorophenyl)-1,3,5-triazin-2-amine, ¹H NMR (CDCl₃) δ 8.84 (s, 1H), 8.24 (d, J=4.9 Hz, 1H); 7.85 (t, J=2.0 Hz, 1H), 7.46 (m, 3H), 7.32 (t, J=8.1 Hz, 1H), 7.14 (m, 1H), 4.74 (br.s, 1H), 1.48 (s, 9H).

(Compound 6) (R⁶═H, R⁷═CH(CH₃)CH₂OCH₂Ph, Ar₁=3-chlorophenyl)

N-(3-chlorophenyl)-4-{2-[(2-(benzyloxy)-1-methylethyl)amino]pyridin-4-yl}-1,3,5-triazin-2-amine, mp 79-80° C.

(Compound 7) (R⁶ and R⁷ form —(CH₂)₂N(CH₂)₂—, Ar₁32 3-chlorophenyl)

N-(3-chlorophenyl)-4-(2-piperidin-1-ylpyridin-4-yl)-1,3,5-triazin-2-amine, mp 168-169° C.

Scheme C

(Compound 1)

A mixture of N-(3-chlorophenyl)-4-(2-chloropyridin-4-yl)-1,3,5-triazin-2-amine (0.20 g, 0.63 mmol) and 1-methoxypropan-2-amine (1.0 mL, 9.48 mmol) in 1,4-dioxane was heated in a bomb at 200° C. overnight. After cooling, the mixture was concentrated and the residue purified by silica gel column chromatography chromatography (eluent hexanes:etheyl acetate, 1:1) to provide N-(3-chlorophenyl)-4-{2-[(2-methoxy-1-methylethyl)amino]pyridin-4-yl}-1,3,5-triazin-2-amine (0.075g, 0.20 mmol).

### Preparation of N-(4-chlorophenyl)-4-(2-piperidin-1-ylpyridin-4-yl)-1,3,5-triazin-2-amine (Compound 8) (R⁶ and R⁷ form —(CH₂)₂N(CH₂)₂—, Ar₁=4-chlorophenyl):

Scheme D:

A solution of N-(3-chlorophenyl)-4-(2-chloropyridin-4-yl)-1,3,5-triazin-2-amine (0.10 g, 1.32 mmol) in piperidine was refluxed overnight. The mixture was concentrated and the residue partitioned between ethyl acetate and water. The organic layer was washed with brine and dried (anhydrous magnesium sulfate). The product N-(4-chlorophenyl)-4-(2-piperidin-1-ylpyridin-4-yl)-1,3,5-triazin-2-amine was obtained as a yellow solid, mp 205-206° C.

### Preparation of 3-{4-[4-(3-Chloro-phenylamino)-[1,3,5triazin-2-yl]-pyridin-2-yl}-4-methyl-oxazolidin-2-one (Compound 9) (R⁶ and R⁷ form a substituted oxazolidinone ring):

### Preparation of 4-methyl-oxazolidin-2-one

To a dry 500 mL round bottom flask was added (in order) 10.0 g (0.135 moles) of 2-amino-propan-1-ol, 75 mls of anhydrous methanol, 65 mls of diethyl carbonate, and 67 mls of 25% sodium methoxide solution in methanol. The reaction mixture is heated to reflux under N₂ for 1.5 hours, changing from clear and colorless to white and cloudy. The mixture was then cooled and stirred overnight at ambient temperature. The solvent was removed in vacuo. 20 mL of 2N aqueous HCl was added and the pH was adjusted to ˜8 using 50% aqueous HCl. Water was removed in vacuo and THF was added to flask to extract residue (3×100). The THF layer was dried with anhydrous magnesium sulfate, filtered, and solvent removed in vacuo. 12.4 g of a pale yellow liquid was isolated which was consistent with the desired product, 4-methyl-oxazolidin-2-one, upon analysis by 300 MHz ¹H NMR.

¹H NMR (CDCl₃) δ 6.85 (bs, 1H), 4.55 (t, 1H); 3.95-4.10 (m, 2H), 1.22 (d, 3H).

### Preparation of 3-{4-[4-(3-Chloro-phenylamino)-[1,3,5]triazin-2-yl]-pyridin-2-yl}-4-methyl-oxazolidin-2-one

A mixture of N-(3-chlorophenyl)-4-(2-chloropyridin-4-yl)-1,3,5-triazin-2-amine (0.50 g, 1.57 mmol), 4-methyl-oxazolidin-2-one (1.6 g, 15.7 mmol), 2,2′-bis(diphenylphosphino)-1,1′-binaphthyl (BINAP) (0.176 g, 0.28 mmol), sodium tert-butoxide (NaOtBu) (0.640 g, 6.6 mmol) in dioxane was degassed at room temperature with nitrogen for five minutes. Tris(dibenzylideneacetone)-dipalladium(0) (palladium catalyst) (0.173 g, 0.19 mmol) was then added and the reaction mixture heated at reflux for 18 hours. After cooling, the solvent was removed in vacuo and the residue taken up into ethyl acetate. The organic mixture was washed with water and the aqueous back-extracted with ethyl acetate. The organics were combined, washed with brine and dried (anhydrous magnesium sulfate). After removal of the solvent, the residue was purified by silica gel column chromatography (eluent hexanes:ethyl acetate, 1:1) to provide 3-{4-[4-(3-Chloro-phenylamino)-[1,3,5]triazin-2-yl]-pyridin-2-yl}-4-methyl-oxazolidin-2-one (0.38 g 64% yield ) as a yellow solid, mp 191-193° C.

¹H NMR (CDCl₃) δ 9.25 (bs, 1H), 8.84 (s, 1H), 8.54 (d, Hz, 1H); 8.05 (d, 1H), 7.46 (m, 3H), 7.32 (m, 1H), 7.14 (m, 1H), 5.15 (m, 1H), 4.60 (t, 1H); 4.10 (m, 1H), 1.55 (d, 3H).

Biological Testing

The technical compounds were formulated at 200 ppm in 10 vol. acetone plus 90 vol. Triton X water (deionized water 99.99 wt. % +0.01 wt. Triton X100), giving a “formulated test compound.” The compounds were tested for ability to control plant diseases at the whole plant level in a 1-day protectant test (IDP). Formulated test compounds were applied to plants using a turn table sprayer fitted with two opposing air atomization nozzles which delivered approximately 1500 L/ha of spray volume. Plants were inoculated with spores of the fungus the next day, then incubated in an environment conducive to disease development. Disease severity was evaluated 4 to 19 days later, depending on the speed of disease development.

The following experiments were performed in the laboratory to determine the fungicidal efficacy of the compounds of the invention.

Leaf Rust of Wheat (causal agent Puccinia recondita tritici=Puccinia triticina, Bayer code PUCCRT): Wheat plants (variety Yuma) were grown from seed in a soilless peat-based potting mixture (Metromix) until the seedlings had a fully expanded first leaf. Each pot contained 3-8 seedlings. These plants were sprayed until wet with the formulated test compounds at a rate of 200 ppm. On the following day, the leaves were inoculated with an aqueous spore suspension of Puccinia triticina and the plants were kept in high humidity overnight to permit spores to germinate and infect the leaf. The plants were then transferred to a greenhouse until disease developed on untreated control plants.

Spot Blotch of Wheat (causal agent Cochliobolus sativus=Bipolaris sorokineana; Bayer code COCHSA): Wheat plants (variety Yuma) were grown from seed in a soilless peat-based potting mixture (Metromix) until the seedlings had a fully expanded first leaf. Each pot contained 3-8 seedlings. These plants were sprayed until wet with the formulated test compound at a rate of 200 ppm. On the following day, the leaves were inoculated with an aqueous spore suspension of Cochliobolus sativus and the plants were kept in high humidity for one to two days to permit spores to germinate and infect the leaf. The plants were then transferred to a greenhouse until disease developed on untreated control plants.

Cucumber Anthracnose (causal agent Colletotricum lagenarium; Bayer code COLLLA): Cucumber plants (variety Bush Champion) were grown from seed in a soilless peat-based potting mixture (Metromix) until the first true leaf was 20-80% expanded. Each pot contained 1 seedling. These plants were sprayed until wet with the formulated test compound at a rate of 200 ppm. On the following day, the leaves were inoculated with an aqueous spore suspension of Colletotricum lagenarium and the plants were kept in high humidity for one day to permit spores to germinate and infect the leaf. The plants were then transferred to a growth chamber until disease developed on untreated control plants.

Glume Blotch of Wheat (causal agent Leptosphaeria nodorum=Stagnospora nodorum; Bayer code LEPTNO): Wheat plants (variety Yuma) were grown from seed in a 50% pasteurized soil/50% soil-less mix until the seedlings had fully expanded first leaf. Each pot contains 3-20 seedlings. These plants were sprayed until wet with the formulated test compound at a rate of 200 ppm. On the following day, the leaves were inoculated with an aqueous spore suspension of Leptosphaeria nodorum and the plants were kept in high humidity (one day in a dark dew chamber followed by four to seven days in a lighted dew chamber) to permit spores to germinate and infect the leaf. The plants were then transferred to a greenhouse until disease developed on untreated control plants.

Rice Blast (causal agent Magnaporthe grisea=Pyricularia oryzae; Bayer code PYRIOR): Rice plants (variety M202) were grown from seed in a soilless peat-based potting mixture (Metromix) until the seedlings had a partly to fully expanded second leaf. Each pot contains 5-20 seedlings. These plants were sprayed until wet with the formulated test compound at a rate of 200 ppm. On the following day, the leaves were inoculated with an aqueous spore suspension of Pyricularia oryzae and the plants were kept in high humidity overnight to permit spores to germinate and infect the leaf. The plants were then transferred to a growth chamber at 22-24C until disease developed on untreated control plants.

Speckled Leaf Blotch of Wheat (Mycosphaerella graminicola=Septoria tritici; Bayer code SEPTTR): Wheat plants (variety Monon) were grown from seed in a greenhouse in 50% pasteurized soil/50% soil-less mix until the first true leaf was fully expanded, with 3-8 seedlings per pot. These plants were sprayed until wet with the formulated test compound at a rate of 200 ppm. On the following day, the leaves were inoculated with an aqueous spore suspension of Septoria tritici and the plants were kept in high humidity (one day in a dark dew chamber followed by four to seven days in a lighted dew chamber) to permit spores to germinate and infect the leaf. The plants were then transferred to a greenhouse until disease developed on untreated control plants.

The following table presents the activity of typical compounds of the present invention when evaluated in these experiments. The effectiveness of the test compounds in controlling disease was determined by assessing the severity of disease on treated plants, then converting the severity to percent control based on the level of disease on untreated, inoculated plants.

Fungicidal activity of compounds in greenhouse tests.

Ratings show the control of disease in one-day protectant tests at a 200 ppm application rate.

Rating scale:

TABLE I

| | Structure | COCHSA | COLLLA | LEPTINO | PUCCRT | PYRIOR | SEPTTR |
|---|---|---|---|---|---|---|---|
| 1 | 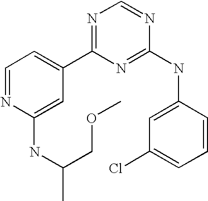 | +++ | +++ | +++ | +++ | +++ | ++ |
| 2 | 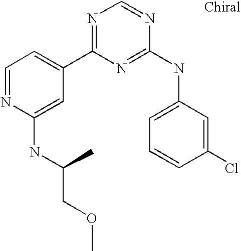 | +++ | +++ | +++ | +++ | +++ | +++ |
| 3 | 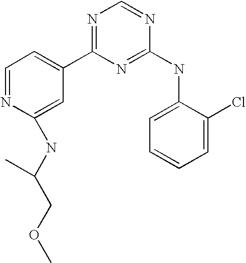 | +++ | − | + | ++ | ++ | + |
| 4 | 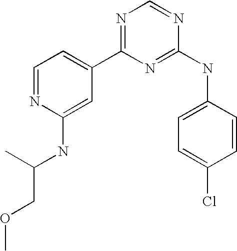 | ++ | − | ++ | ++ | − | ++ |
| 5 | 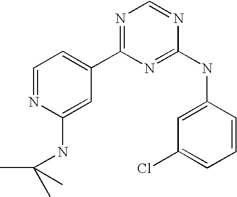 | +++ | ++ | ++ | +++ | +++ | +++ |
| 6 | 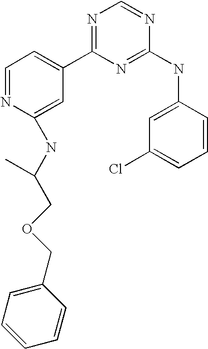 | ++ | − | ++ | +++ | − | +++ |
| 7 | 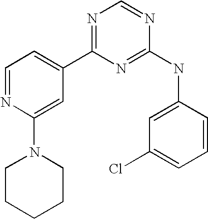 | + | − | ++ | + | − | ++ |
| 8 | 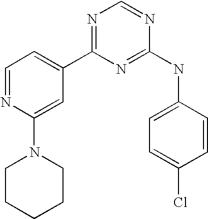 | − | − | ++ | − | − | ++ |
| 9 | 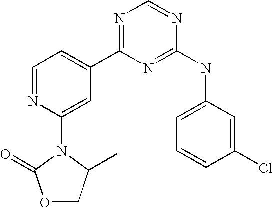 | +++ | + | ++ | +++ | +++ | ++ |

− indicates control of disease less than or equal to 20% of plant coverage
+ indicates control of disease of 21-49% of plant coverage
++ indicates control of disease of 50-89% of plant coverage
+++ indicates control of disease of 90-100% of plant coverage

1. A composition used in protecting plants against infestation by phytopathogenic microorganisms or in treating plants, which have been infested with phytopathogenic microorganisms, comprising a disease-inhibiting and phytologically acceptable amount of a compound of the formula: 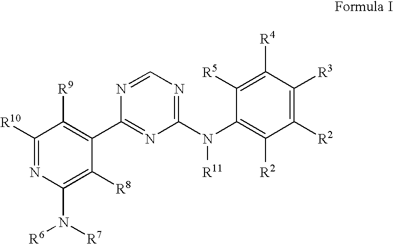
wherein
R¹, R², R³, R⁴, and R⁵ are each independently selected from H, alkyl, halogen, alkylhalo, alkoxy, alkoxyhalo or cyano;
R⁶ and R⁷ are each independently selected from H, alkyl, cycloalkyl, alkenyl, alkylalkenyl, alkylalkynyl, aryl, alkylaryl, alkylhalo, alkoxy, alkylalkoxy, alkylalkoxyalkoxy, alkylalkoxyhalo, alkylhydroxy, alkylaryloxy, or alkylamino, or when taken together R⁶ and R⁷ can form a saturated or unsaturated 5 or 6 membered ring selected from piperazine, piperidine, morpholine, thiomorpholine, pyrrolidine, oxazolidine, oxazolidinone, thiazolidine, tetrahydroisoquinoline, decahydroisoquinoline, pyrroline, or tetrahydropyridine, wherein the 5 or 6 membered ring can be additionally substituted with one or more alkyl, aryl, cycloalkyl, alkylaryl, alkoxy, halo, and/or amino groups; and
R⁸, R⁹, and R¹⁰ are each independently selected from hydrogen, alkyl, halogen, haloalkyl, or alkoxy, and
R¹¹ is selected from H, alkyl, alkenyl, alkylalkenyl, alkylalkynyl, CH₂OR¹², CH₂SR¹², —C(O)R¹², C(O)OR¹², SO₂R¹², SOR¹², or SR¹², wherein
R¹² is selected from alkyl, alkylalkoxy, alkylhalo or alkylphenyl, wherein the phenyl may be substituted by up to 3 groups selected from halo or alkyl.

2. The composition of claim 1 wherein R⁶ and R⁷ are each independently selected from H, alkyl, branched alkyl, cycloalkyl, alkenyl, branched alkenyl, alkylalkenyl, branched alkylalkenyl, alkylalkynyl, branched alkylalkynyl, aryl, alkylaryl, alkylhalo, alkoxy, alkylalkoxy, alkylalkoxyalkoxy, alkylalkoxyhalo, alkylhydroxy, alkylaryloxy, or alkylamino.

3. The composition of claim 1 wherein
R¹, R², R³, R⁴, and R⁵ are each independently selected from H, alkyl, halogen, alkylhalo, alkoxy or alkoxyhalo;
R⁶ and R⁷ are each independently selected from H, alkyl, cycloalkyl, alkenyl, alkylalkenyl, alkylalkynyl, aryl, alkylaryl, alkylhalo, alkoxy, alkylalkoxy, alkylalkoxyalkoxy, alkylalkoxyhalo, alkylhydroxy, alkylaryloxy, or alkylamino;
R⁸, R⁹, and R¹⁰ are each independently selected from hydrogen, alkyl, halogen, haloalkyl, or alkoxy; and
R¹¹ is selected from H, alkyl, alkenyl, alkylalkenyl, alkylalkynyl, or CH₂OR¹², wherein
R¹² is selected from alkyl, alkylalkoxy, alkylhalo or alkylphenyl, wherein the phenyl may be substituted by up to 3 groups selected from halo or alkyl.

4. The composition of claim 3 wherein
R¹, R², R³, R⁴, and R⁵ are each independently selected from H or halogen;
R⁶ and R⁷ are each independently selected from H, alkyl, alkenyl, alkylalkenyl, alkylalkynyl, aryl, alkylaryl, alkylhalo, alkoxy, alkylalkoxy, alkylalkoxyalkoxy, alkylalkoxyhalo, alkylhydroxy, alkylaryloxy, or alkylamino;
R⁸, R⁹, and R¹⁰ are each H, and
R¹¹ is H.

5. The composition of claim 4 wherein
R¹, R², R³, R⁴, and R⁵ are each independently selected from H or halogen;
R⁶ and R⁷ are each independently selected from alkyl or alkylalkoxy.

6. The composition of claim 1 wherein the composition comprises from 1 to about 1000 ppm of the compound of Formula I or salt thereof.

7. A method of controlling and preventing an infestation of phytopathogenic microorganisms in plants, which comprises contacting a plant, a part of a plant, or the locus thereof with; or applying to the soil a composition of claim 1.

8. A compound of the Formula: 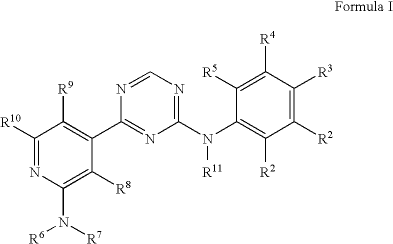
wherein
R¹, R², R³, R⁴, and R⁵ are each independently selected from H, alkyl, halogen, alkylhalo, alkoxy, alkoxyhalo or cyano;
R⁶ and R⁷ are each independently selected from H, alkylalkoxy, alkylalkoxyalkoxy, or together form an optionally substituted oxazolidinone ring,
R⁸, R⁹, and R¹⁰ are each independently selected from hydrogen, alkyl, halogen, haloalkyl, or alkoxy; and
R¹¹ is selected from H, alkyl, alkenyl, alkylalkenyl, alkylalkynyl, CH₂OR¹², CH₂SR¹², —C(O)R¹², C(O)OR¹², SO₂R¹², SOR¹², or SR¹², wherein
R¹² is selected from alkyl, alkylalkoxy, alkylhalo or alkylphenyl, wherein the phenyl may be substituted by up to 3 groups selected from halo or alkyl.

9. The compound of claim 8 wherein
R¹, R², R³, R⁴, and R⁵ are each independently selected from H, alkyl, halogen, alkylhalo, alkoxy or alkoxyhalo;
R⁸, R⁹, and R¹⁰ are each independently selected from hydrogen, alkyl, halogen, haloalkyl, or alkoxy; and
R¹¹ is selected from H, alkyl, alkenyl, alkylalkenyl, alkylalkynyl, CH₂OR¹², wherein
R¹² is selected from alkyl, alkylalkoxy, alkylhalo or alkylphenyl, wherein the phenyl may be substituted by up to 3 groups selected from halo or alkyl.
